(19) United States
(12) Patent Application Publication
(10) Pub. No.: US 2024/0095833 A1
(43) Pub. Date: Mar. 21, 2024

(54) Real-Time Equity Monitoring System, Process and Interface

(71) Applicant: Gapodox, LLC, San Juan, PR (US)

(72) Inventors: Roberto ZAYAS, San Juan, PR (US); Daniel REYNOLDS, Washington, MI (US)

(21) Appl. No.: 18/370,852

(22) Filed: Sep. 20, 2023

Related U.S. Application Data
(63) Continuation-in-part of application No. 17/948,156, filed on Sep. 19, 2022.
(60) Provisional application No. 63/408,425, filed on Sep. 20, 2022.

(51) Int. Cl. G06Q 40/06; G06Q 40/04

(52) U.S. Cl. CPC G06Q 40/06; G06Q 40/04

(57) ABSTRACT

A method for generating a dynamic interface to display real-time information about a plurality of tradeable assets within a portfolio. The method includes receiving real-time data for each of the plurality of tradeable assets and generating a node for each tradeable asset. The nodes include a first characteristic indicative of a volume relative to the portfolio and a second characteristic indicative of a trading momentum. The method includes generating the dynamic interface which includes positioning each node within a circular common area, with the position between a center of the circular common area and an outer edge of the circular common area, the position based on the first characteristic of each node. One or more nodes has an angular movement based on the second characteristic, and the dynamic interface updates with real-time changes in the data of any of the plurality of tradeable assets.

### PRIORITY CLAIM AND RELATED APPLICATIONS

This application, which claims the benefit of provisional U.S. Application No. 63/408,425 entitled “Real-Time Equity Monitoring System, Process and Interface,” filed Sep. 20, 2022, is a continuation-in-part application of co-pending U.S. application Ser. No. 17/948,156 entitled “Real-Time Equity Monitoring System, Process and Interface,” filed Sep. 19, 2022, which claims the benefit of provisional U.S. Application No. 63/295,668 entitled “Real-Time Equity Monitoring System, Process and Interface,” filed Dec. 31, 2021, the technical disclosures of which are hereby incorporated by reference in their entirety.

### BACKGROUND

### 1. Field of the Invention

This application relates generally to methods and apparatus for controlling operation of a computer display to display efficiently information and, more specifically, to user-configurable methods using an apparatus for concurrently and graphically displaying a diverse data set within a common region of a computer display.

### 2. Description of Related Art

Conventional control systems for displaying information such as financial information indicative of an equity's performance often divide the information into different sets. For example, charts can be created to display a trend of the equity's price over a defined period of time. Some systems will overlay a plurality of line graphs representing historical price trends for different equities over the defined period of time on the same chart. Viewers of such a chart can readily compare the historical performance of those different equities over the period of time represented.

However, aside from selecting the equities to be represented on the chart, and possibly the period of time encompassed by the chart, users are left with little flexibility to include additional, different information to be presented on a conventional chart for their analysis. Instead, users are required to access separately different information by navigating to a different portion of a network-accessible application. For example, users are typically required to navigate away from the displayed chart to a table of historical dividend information to view information about an equity's dividend history. Other information about the equity would also require navigating to a different interface of a network-accessible application to be viewed. In each instance, the various information viewable from the different interfaces of the network-accessible application must be remembered by the user, or written down for consideration while viewing other information. Navigating between different interfaces of a network-accessible application is not only time consuming and inefficient, but also prevents users from contemporaneously considering multiple different data sets.

More recently, bespoke applications have been developed to include interfaces that can present different data within a common interface. Bespoke solutions allow a plurality of equities to be selected for inclusion within the interface, but they are prohibitively expensive for most private users. Further, modifying bespoke solutions to vary the types of data to be included within a common interface requires amending the application at the program code level, involving dedicated software developers for such an undertaking.

### SUMMARY

Accordingly, there is a need in the art for a system, apparatus, platform and method of allowing users to configure an application to include a plurality of different categories of information, about a plurality of different tradeable assets in a common user interface. Configuration of the application can involve receiving user input specifying the categories of information from a menu included in a graphical user interface, optionally without modification of the application at a program code level.

According to one aspect, the subject application involves a method for generating a dynamic interface with a computing system to display real-time information about a plurality of tradeable assets within a portfolio. The method can include receiving data for each of the plurality of tradeable assets, wherein the data is received in real-time. The method can further include generating a node for each tradeable asset of the plurality of tradeable assets based on the data of each tradeable asset. Each node includes a first characteristic indicative of a volume relative to the plurality of tradeable assets within the portfolio and a second characteristic indicative of a trading momentum.

The method can further include generating the dynamic interface to display the real-time information about the plurality of tradeable assets. The dynamic interface may include the node for each tradeable asset located within a circular common area of the dynamic interface. Each node has a position between a center of the circular common area and an outer edge of the circular common area, the position based on the first characteristic of each node. One or more nodes has an angular movement based on the second characteristic, and the dynamic interface updates with real-time changes in the data of any of the plurality of tradeable assets.

In another aspect, the subject application involves a non-transitory computer readable medium. The non-transitory computer readable medium stores instructions that when executed by one or more processors cause the one or more processors to receive data for each of a plurality of tradeable assets, wherein the data is received in real-time.

The instructions further cause the one or more processors to generate a node for each tradeable asset of the plurality of tradeable assets based on the data of each tradeable asset. Each node includes a first characteristic indicative of a volume relative to the plurality of tradeable assets within the portfolio and a second characteristic indicative of a trading momentum. The instructions further cause the one or more processors to generate a dynamic interface to display the real-time information about the plurality of tradeable assets. The dynamic interface may include the node for each tradeable asset located within a circular common area of the dynamic interface. Each node has a position between a center of the circular common area and an outer edge of the circular common area, the position based on the first characteristic of each node. One or more nodes has an angular movement within the circular common area, the angular movement based on the second characteristic, and the dynamic interface updates with real-time changes in the data of any of the plurality of tradeable assets.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented in the pages that follow.

### BRIEF DESCRIPTIONS OF THE DRAWINGS

The invention may take physical form in certain parts and arrangement of parts, embodiments of which will be described in detail in this specification and illustrated in the accompanying drawings which form a part hereof and wherein:

FIG. 1 shows an illustrative embodiment of a computer-based system for controlling operation of a display to generate an interface including different categories of content, for a plurality of different tradeable assets within a common region of the interface.

FIG. 2 is a flow diagram schematically illustrating an illustrative embodiment of a computer-implemented process for controlling operation of a display to generate a graphical user interface that concurrently presents different categories of content, for a plurality of different tradable assets.

FIG. 3 shows an illustrative embodiment of a category content menu allowing user configuration of the categories of content to be represented in a graphical user interface.

FIG. 4 shows an illustrative embodiment of a tradeable asset menu allowing user configuration of the tradeable assets to be represented in a graphical user interface.

FIG. 5 shows an illustrative embodiment of an interface that includes a common region that concurrently displays graphical representations of numeric data and transaction data relating to a plurality of tradeable assets.

FIG. 6 is another flow diagram schematically illustrating an illustrative embodiment of a computer-implemented process for controlling operation of a display to generate a graphical user interface that concurrently presents different categories of content, for a plurality of different tradable assets.

FIG. 7A shows an illustrative embodiment of a dynamic interface of a plurality of nodes representing tradeable assets.

FIG. 7B shows another illustrative embodiment of a dynamic interface of a plurality of nodes representing tradeable assets.

FIG. 8A shows an illustrative embodiment of a connection indicator between tradeable assets.

FIG. 8B shows an illustrative embodiment of industries and sectors regarding the connection indicator.

FIG. 9 shows an illustrative embodiment of a dynamic interface of a plurality of wedges representing tradeable asset classes.

FIG. 10 illustrates an embodiment of a computing system configured with the systems and/or processes disclosed herein.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

There is a need in the art for apparatus and methods for controlling operation of a computer display to generate an interface including different categories of content, for a plurality of different tradeable assets within a common region of the interface. The migration of equities trading to electronic exchanges accessible over a communication network such as the Internet, for example, has made real-time information readily available to traders conducting research on equities and other tradeable assets. Traders have traditionally been required to collect different types of information for individual equities from different interfaces, such as a summary page, a table of historical dividend payments, a compilation of insider transactions, etc. Each different category of information would then be separately considered by traders to make a decision regarding whether to buy, sell or hold each individual equity.

The above process is time consuming for traders with large portfolios because individual equities were researched separately. Further, the above process is substantially the same process performed by traders in the pre-Internet era, although using more up-to-date information. Rather than compiling different categories of information about equities from printed publications, real-time data is retrieved electronically from a database. The end result is that traders separately considered different categories of information about equities, individually, and then moved on to research the next equity of interest.

In contrast, the present technology controls operation of a computer display to generate an interface comprising a common region that concurrently displays content within a plurality of different categories, for a plurality of different tradeable assets such as equities. The technology is user configurable, which allows the user to select or otherwise specify, without modification at a program code level of an executable application: (i) the different tradeable assets, and (ii) the different categories of content to be concurrently displayed in the common region of the interface for each of the different tradeable assets. Data falling within each of the different categories can be retrieved for each of the selected equities over a communication network such as the Internet, for example, and concurrently and graphically represented within the common region of the interface. Upon viewing the common region of the interface, a trader can readily glean for each equity, based on graphical elements within the common region, one, a plurality, or all of:
(i) whether one or more particular events has occurred and/or will occur,
(ii) a timing of any events that have occurred and/or will occur,
(iii) a quantity of events that have occurred,
(iv) whether the equity offers an occasional distribution, and
(v) and a recommendation whether to conduct a transaction involving the equity.

Unlike traditional technologies, the present technology allows traders to configure a portfolio of tradeable assets and all categories of content desired by the traders to be concurrently displayed using graphical elements within a common region of an interface. As a result, significantly more information can be aggregated from remote terminals, and displayed within the region of the interface than if the underlying data was displayed in a purely alpha-numeric format. Because much of the underlying data changes in real time based on activity occurring on the electronic exchanges as sales, option grants/exercises, dividend payments, etc. occur, the present technology allows for consideration of large amounts of data in a timely fashion, before conditions change. The display controlled as described herein can therefore present a larger quantity of information than it otherwise could by displaying the underlying data. Further, the concurrently-displayed graphical elements convey trends in the underlying data that may not be immediately visible from a purely alpha-numeric display. Traders are able to evaluate all categories of content graphically represented within the common region of the interface, for a full portfolio of tradeable assets. Such an evaluation can occur without requiring traders to navigate to various different interfaces and separately evaluate different categories of content, for an individual tradeable asset, greatly improving the efficiency of the interface. The portfolio configuration can optionally be saved by traders in a user account, to be opened and updated without requiring a trader to reconfigure the portfolio.

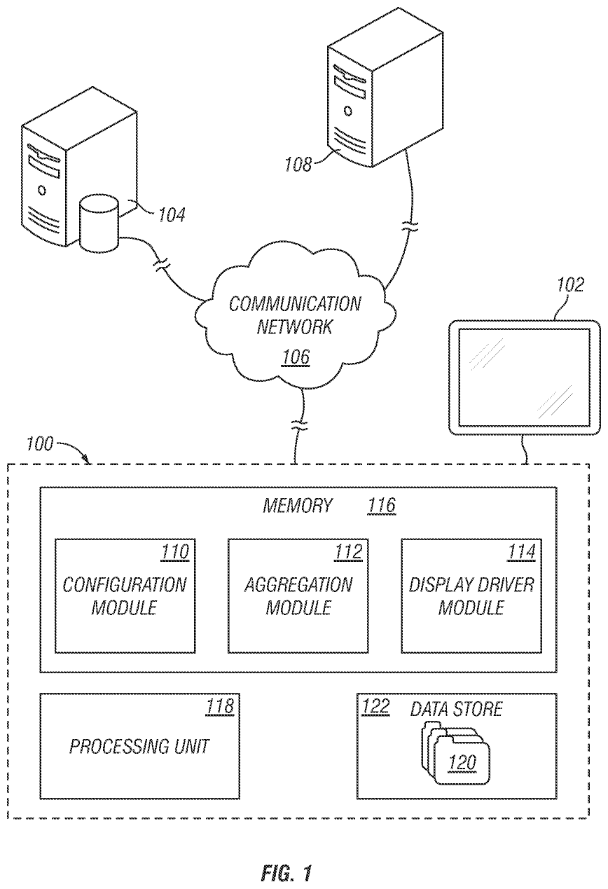

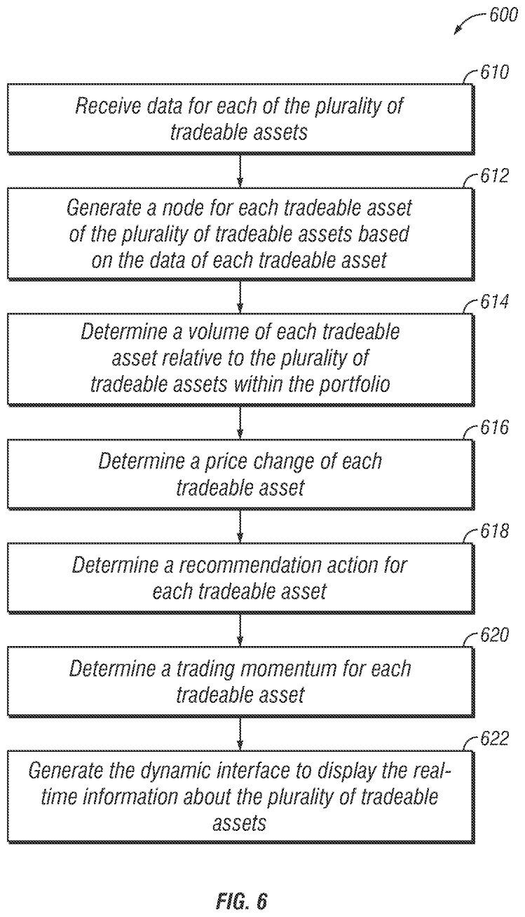

With reference to the drawings, FIG. 1 shows an illustrative embodiment of a computing system 100 for controlling operation of a computer display 102 to display a graphical user interface, as described below. The graphical user interface includes different categories of content, for a plurality of different tradeable assets, graphically represented within a common region of the interface. In one embodiment, the computing system 100 is implemented as a computing device 600 described in detail below with respect to FIG. 6. According to another embodiment, the computing system 100 is a computing/data processing system including an application or collection of distributed applications for enterprise organizations. The applications and computing system 100 may be configured to operate with, or be implemented as a cloud-based networking system, a software as a service (SaaS) architecture, a node in a cluster computing system or another type of network architecture.

In one embodiment, the computing system 100 is a centralized server-side application that performs at least the computerized functions disclosed herein and that electronically communicates with a plurality of nodes such as a database server 104, for example, over a communications network 106 such as the Internet. The computing system 100 and one or more remote terminals such as the database server 104 can optionally operate together to store and process data as described herein.

The present disclosure describes embodiments of the computing system 100 as a client-side application locally connected to the computer display 102 for the sake of brevity and clarity. However, alternate embodiments of the computing system 100 can be deployed as a server-side, hosted application that performs the functions described herein, for concurrent connections with a plurality of network-connected terminals. For example, web server 108 can be configured with a hosted application accessible by remote terminals such as the computing system 100 over the communication network 106. The web server 108 can access the database server 104 to retrieve data included in different categories of content as described herein, and to serve content over the communication network 106 to the computing system 100 to be displayed by the computer display 102.

One or more of the components of the computing system 100 can be embodied as program modules (e.g., configuration module 110, aggregation module 112, display driver module 114) stored in a memory 116 of the computing system 100. The program modules are configured with instructions that, when executed by circuitry of at least a processing unit 118, cause the computing system 100 to perform the corresponding function(s).

As described in greater detail with reference to FIG. 6, the processing unit 118 can be, for example, one or more hardware processors, such as, a microprocessor, central processing unit (CPU), application-specific integrated circuit (ASIC), or similar hardware device, or array thereof. The processing unit 118 is connected via circuitry (e.g., a bus) to the memory 116 and to the data store 122 via one or more input/output controllers. The memory 116 is, for example, a non-transitory memory such as a cache memory of a processor, a flash memory, a random-access memory (RAM), cache memory or other active memory that stores instructions executed by the processing unit 118.

One or more data structures 120 storing data of a user account associated with a trader can be stored in the data store 122. The data store 122 can be, for example, a flash memory, hard-disk drive or similar volatile or non-volatile computer-storage media. Accordingly, the processing unit 118 uses the data store 122 and/or the memory 116 to store various data when performing the functions described herein. As shown in FIG. 1, the data store 122 is integrated with the computing system 100. Of course, in other embodiments, the data store 122 can be implemented as a distributed storage that is shared among one or more remote devices such as the database server 104 and the web server 108, and the computing system 100 in a distributed file system.

As used herein, the communication network 108 comprises a computer network hardware, software applications, public communication transmission components such as public telephone switching networks and the like to facilitate packetized or other communications between the computing system 100 and remote devices as described herein. For example, the communication network 108 can comprise a local area network (“LAN”), a wide area network (“WAN”), the Internet, or a combination thereof.

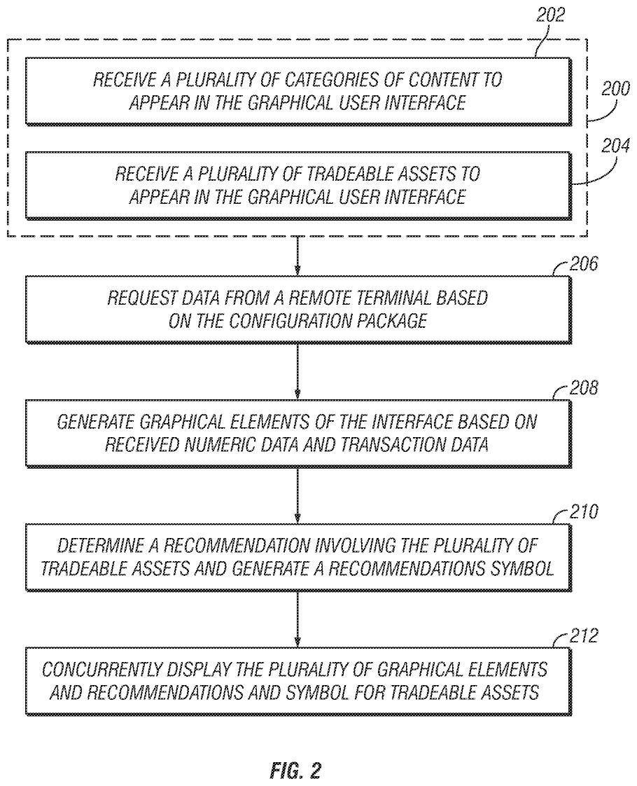

An illustrative embodiment of a computer-implemented process of controlling operation of the computer display 102 to generate a graphical user interface is shown in FIG. 2. The graphical user interface concurrently and graphically presents content in a plurality of different categories, for a plurality of different tradeable securities, within a common display region of the interface.

At block 200 in FIG. 2, the configuration module of the computing system receives a configuration package that defines the categories of content, and the tradeable assets that are to be concurrently displayed within the common region of the interface. For example, as part of the configuration package, the configuration module receives user-defined categories of content at block 202, and a plurality of tradeable assets at block 204. The categories of content are described herein as being user-configurable, or user-defined, meaning a user of the present technology can individually select, or otherwise specify the categories the user desires to appear in the interface.

At block 206, the aggregation module communicates with the remote server over the communication network to request and retrieve data within the categories of content, and for each of the tradeable assets specified in the configuration package. The data requests at least numeric data and transaction data corresponding to the tradeable assets. According to some embodiments, the numeric data for each selected tradeable asset includes, but are not limited to:
sales prices of the tradeable assets involved in transactions (e.g., sales) that occurred within a defined historical period of time preceding the date on which the data is requested,
the current market price of the tradeable asset at the time the data is requested, and option strike prices for the tradeable asset at the time the data is requested.

Examples of the transaction data for each tradeable asset selected include, but are not limited to:
Historical trades (e.g., purchases, sales and option grants) involving insiders affiliated with the corporation related to the tradeable asset, or have access to information related to the tradeable security that is not publicly available. As specific examples, the information about historical trades requested can include at least one of, for each of the tradeable assets selected, a name and title of the insiders who have traded the tradeable asset, dates on which the insiders have traded the tradeable asset, a volume of the tradeable asset traded by the insiders, and whether the insider has engaged in at least one of: (i) a purchase of the tradeable asset, (ii) a sale of the tradable asset, (iii) an exercise of an option issued for the tradeable asset, and (iv) a receipt of a grant of the tradeable asset, and
upcoming dividend payments scheduled to be paid to holders of the tradeable security within a defined period of time from the date on which the data is requested.

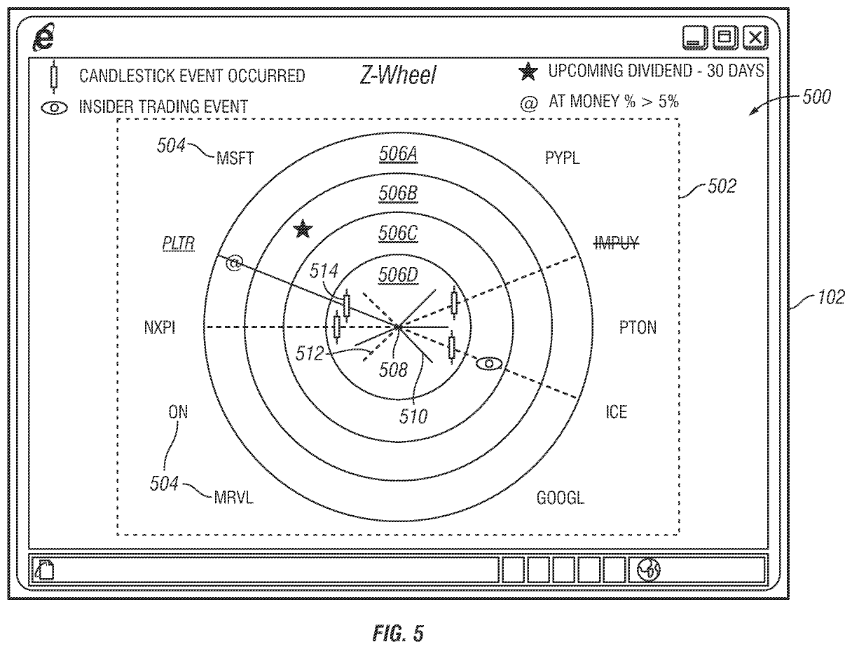

At block 208 in FIG. 2, the display driver module generates graphical elements of an interface, an illustrative embodiment of which is shown in FIG. 5, based on the numeric data and the transaction data received by the aggregation module. For example, the interface 500 can include a common region 502 (enclosed by broken lines) in which each of the graphical elements is concurrently displayed, to convey graphically information related to the numeric data and the transaction data received by the aggregation module.

Referring again to FIG. 2, based on the totality of factors specified in the configuration package, the display driver module determines, at block 210, a recommendation involving each of the plurality of tradeable assets represented in the common region (see FIG. 5) of the interface.

At block 212 in FIG. 2, the display driver module controls transmission of a signal to the display, to cause the display to present the interface to the user. Based on the information graphically conveyed by the interface, the user can initiate a recommended transaction involving one or more of the tradeable assets. The interface includes the common region in which, for each of the tradeable assets in the configuration package, an activity symbol is arranged within a central region of the common region, the dividend symbol overlays a portion of the activity symbol, and the recommendation symbol is arranged about a perimeter region of the activity symbol. According to alternate embodiments, the display driver module can transmit a signal that automatically triggers a transaction involving the tradeable asset, without human intervention, based on the recommendations determined by the display driver module.

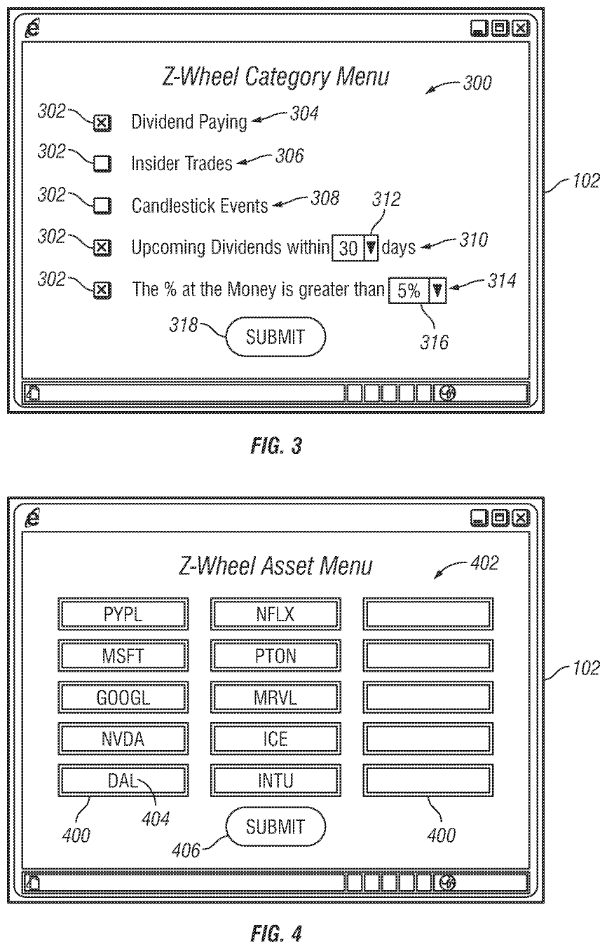

Turning to FIG. 3, by way of example, a defined list of available categories can be displayed in a menu 300 by the computer display as shown in the embodiment of FIG. 3. The user can select check boxes 302 for a plurality (but fewer than all available options), or all available options of categories available from the menu 300. According to alternate embodiments, any suitable selection mechanism other than check boxes 302, such as radio buttons, pull-down menus, text entry fields, etc. can be used in place of, or in addition to the check boxes 302 shown in FIG. 3.

For the embodiment shown in FIG. 3, the menu 300 includes the following available categories of content to be included in the interface:

dividend paying tradeable assets 304—designation of those tradeable assets selected for inclusion that issue occasional, and optionally regular distributions of currency.

insider trades involving the tradeable asset 306—indications of whether trades have occurred within a defined time frame, involving the tradeable asset by any party that has access to information material to the price of the tradeable asset that is not available to the general public.

Candlestick events 308—a price chart format that can be used for technical analysis includes a graphic that concurrently displays high, low, open, and closing prices for a specific period for a given financial instrument is referred to as a “candlestick” chart. Designed similar to the candlestick marker (discussed below in further detail and shown in FIG. 5), the candlestick includes an upper tail and lower tail that represent the high and low prices, respectively, achieved for the instrument during a time period, typically a trading session such as a day for example. The body segment is rectangular in shape, and represents the opening and closing for a trading period, and can be color coded to represent whether the instrument closed at a higher or lower price than it opened. Patterns can be both simple and complex, and optionally user-definable through the selection of desired criteria via interfaces within the menu 300. For example, the user can establish candlestick criteria that includes at least one of a threshold: opening price, closing price, high price, and low price during a trading session. Satisfaction of at least one, a plurality (but less than all), or all of the candlestick criteria during a trading session constitutes a candlestick event. Although the foregoing example describes a candlestick pattern as defining high, low, close and open prices, it is understood that other patterns indicative of market manipulation can constitute “candlestick” patterns, as used herein. For example, criteria can be user-defined in the menu 300 to be satisfied according to so-called EG Wyckoff distribution patterns can be used to determine when/if “candlestick” events have occurred. Wyckoff patterns are helpful to determine when large-volume investors build short positions or distribute long positions and surpass the activity of retail traders. The large-volume investors distribute positions gradually to avoid the price from changing significantly before they can complete their distributions. For the sake of brevity and clarity, however, embodiments utilizing the high, low, close open criteria of candlestick events are described herein.

upcoming dividend or other distribution 310 scheduled to be paid within a defined period of time 312 defined by the user from a date on which the data is to be requested; and
a percentage of at the money 314 exceeds a defined percentage 316 specified by the user—a percentage of the tradeable asset that is at a market price within the defined percentage 316 (or other tolerance) of an option strike price for a defined percentage of outstanding options to purchase the tradeable asset. However, other embodiments of the technology can include a subset of the options in the menu 300, or additional options not shown in the embodiment of the menu 300 in FIG. 3. Upon selecting the desired categories of content, the selection can be submitted for inclusion in the configuration package in response to selection of the confirmation button 318.

In addition to the desired categories of content, the user can also define the plurality of tradeable assets to be included in the interface. For the illustrative embodiment shown in FIG. 4, ticker symbol entry fields 400 can be included in a tradeable asset selector 402. Stock ticker symbols representing equities of specific corporations can be entered in each field for inclusion in the configuration package defining the tradeable assets represented in the interface. In FIG. 4, the ticker symbol DAL 404 is typed into one of the ticker symbol entry fields 400. In response to selection of the confirm button 406, the equities of Delta Airlines and other tradeable assets will be incorporated into the configuration package, to be included in the interface. According to alternate embodiments, the name, or a portion of the name of the corporation can be entered into the ticker symbol entry fields 400, and a lookup will be performed in the background. According to some embodiments, at least ten (10), and up to fifty (50) tradeable assets can be submitted in the configuration package for inclusion in the interface.

The configuration package includes the user-definable settings for generation of the interface as described herein, and is stored by the configuration module in a data structure in the data store. The data structure can also associate the configuration package with a user account of the user, allowing the user to save the configuration package for future evaluations of the user's portfolio. By specifying the categories of content and the tradeable assets that are to appear in the interface, the user is able to configure the computing system to display the desired content without modifying the source/program code of the configuration module.

Referring to FIG. 5, an interface 500 that includes a common region 502 that concurrently displays graphical representations of numeric data and transaction data relating to a plurality of tradeable assets is shown. According to the embodiment shown in FIG. 5, the plurality of ticker symbols 504 defined by the configuration package are arranged about a periphery of a plurality of concentrically-aligned, annular regions 506A, 506B, 506C, 506D. Information pertaining to each ticker symbol 504 is designated by placement of one or more graphical elements in the annular regions 506A, 506B, 506C, 506D, extending in a radial direction from an origin 508 towards the respective ticker symbol 504. Placement of the ticker symbols 504 may be indicative of the volume of the tradeable assets corresponding to the ticker symbols. In one embodiment, the placement of the ticker symbols 504 is indicative on increasing volume, with volume increasing in a clockwise direction. For example, PYPL would have the smallest volume relative to the portfolio and MSFT would have the largest volume relative to the portfolio. In another embodiment, the placement of the ticker symbols 504 is indicative on increasing volume, with volume increasing in a counterclockwise direction. For example, MSFT would have the smallest volume relative to the portfolio and PYPL would have the largest volume relative to the portfolio.

The interface 500 may further include a line extending from the origin 508 toward each ticker symbol 504. The lines can be dividend symbols that include at least: (i) a first variable aspect, and (ii) a second variable aspect. An example of the first variable aspect can be an appearance of the line that graphically indicates whether a dividend is paid to holders of the tradeable asset. In FIG. 5, for example, a solid line 510 having a relatively-light line weight indicates that the tradeable asset with the corresponding ticker symbol, GOOGL in this example, does not pay a dividend. In contrast, a broken line 512 having a relatively-heavy line weight indicates that the tradeable asset with the corresponding ticker symbol, MRVL in this example, does pay a dividend. However, other graphical aspects of the line such as a color code, a size, a shape, or any other graphical element can be utilized as the first variable aspect. For example, a first color line (e.g., grey) may graphically indicate that the tradeable asset and a second color line (e.g., green) may indicate that the tradeable asset pays a dividend

The second variable aspect of the lines can graphically indicate a relative quantity of events that occurred, or are scheduled to occur involving the tradeable asset. According to the illustrative embodiment in FIG. 5, the longer the line, the greater the number of events that have occurred, or are scheduled to occur involving the tradeable asset. As a specific example, a number of events that have occurred involving the tradeable asset ICE is greater than a number of events that have occurred involving the tradeable asset PTON. However, other graphical aspects of the line such as a color code, a size, a shape, or any other graphical element can be utilized as the first variable aspect. According to some embodiments, examples of the events include, but are not limited to: candlestick events, insider trades, impending dividend events, any other event, and any combination thereof. Thus, for the embodiment shown in FIG. 5, the first variable aspect (e.g., solid, low-weight line v. broken, heavy-weight line) indicates whether the respective tradeable asset pays a dividend, and the second variable aspect (length of line) indicates a number of events that have occurred, or will occur.

In addition to the lines, additional symbols can be arranged within the annular regions 506A, 506B, 506C, 506D, in the radial direction extending from the origin 508 to the respective ticker symbol 504. For example, a marker such as the “at” symbol (@) can be placed in annular region 506A, which can be designated for markers that identify tradeable assets for which the “at the money” percentage exceeds the user-configurable percentage specified in the configuration package. The “at the money” percentage is a percentage of the outstanding options for a tradeable asset that, at the current market price, is within a defined tolerance of the option strike price. In the illustrative embodiment of FIG. 5, the defined tolerance was specified as five (5%) in the configuration package.

Similarly, annular region 506B can be designated to display markers such as a star (★), which is indicative of an upcoming dividend payment within a user-defined period from the date on which the numeric and transaction data is received by the aggregation module 112. In the example of FIG. 5, the star (★) indicates the tradeable asset MSFT has an upcoming dividend payment within the next thirty (30) days.

Annular region 506C can be designated to display markers such as an eye, which indicates an insider trading event has occurred. Insider trades involve a transaction involving the respective tradeable asset by a party who has information that is not available to the general public. Whether an insider trading event has occurred is determined by the display driver module based on transaction data received by the aggregation module.

Annular region 506C can be designated to display markers such as candlestick marker 514 in FIG. 5. The candlestick marker 514 includes a vertical, rectangular section that indicates the open and close prices of the tradeable asset, an upward projecting line that identifies the high price achieved by the tradeable asset during a trading session, and a downward projecting line that identifies the low price achieved by the tradeable asset during the trading session. The configuration package can optionally be configurable by the user to specify the high, low, open close prices to be satisfied for designation of a tradeable asset with the candlestick marker 514.

The common region 502 may comprise additional annular regions. For example, an annular region may be designated to display markers indicative of a strong or weak lunar phase performance for a tradeable asset, which may be based on the received data. If an asset performs better around a new moon phase, an indication will be presented notifying the user that the tradeable asset will be entering a historically better performing period. Alternatively, a different indication may be presented notifying the user that the tradeable asset will be entering a historically weaker performing period if in the full moon phase. Thus, it is advantageous to provide the user with indications of lunar cycle performance that enables the user to capitalize on the forthcoming performance.

The common region 502 may also comprise a natural ratio region. The natural ratio region may be based on the correlation of the trading movement of a tradeable asset and the Fibonacci sequence. The natural ratio is obtained by diving successive pairs of Fibonacci numbers, yielding approximately 1.618 (or conversely 0.618). The natural region may utilize Fibonacci retracements, Fibonacci arcs, Fibonacci fans, Fibonacci zones, or any combination thereof to determine the natural ratio for a tradeable asset. The determination may also utilize other methods known in the art. For example, an annular region may be designated to display markers indicative of a strong or weak performance for a tradeable asset correlated to the natural ratio based on the received data. If an asset is projected as performing better in the future, an indication will be presented notifying the user that the tradeable asset will be entering a historically better performing period. Alternatively, a different indication may be presented notifying the user that the tradeable asset will be entering a historically weaker performing period if projected to lose value.

The common region 502 may also comprise a crowded short selling region. The crowded short selling region may be based on data indicating a large amount of short selling positions for a tradeable asset, indicating increased risk in purchasing a short position on the tradeable asset. If an asset is demonstrating a crowded short sell tendency, an indication will be presented notifying the user that the tradeable asset will be entering a risky performing period. The common region 502 may also comprise a call option region and/or a put option region. The option regions provide a user with information indicating whether other investors are predicting a strong or weak performance on the tradeable asset. An indication will be presented notifying the user that the tradeable asset will be entering a projected better performing period based on the option positions. Accordingly, it is advantageous to provide annular regions and corresponding indications in this manner because the user can make decisions with all pertinent information on one screen. Thus, the user can promptly execute trades, maximizing the value of the trade. Without having information presented in this manner, a user would not be able to execute prompt trades and fail to maximize the position.

In each of the above-described embodiments for the tradeable assets, artificial intelligence (AI) may be employed to manage the user's investments based performance. The AI may suggest trading recommendations based on, for example, the user's trading tendencies. For example, the AI may provide buy or sell recommendations for the user's tradeable assets based on the user's historical actions for candlestick events, insider trading events, upcoming dividends (or no dividends), at the money, and/or natural ratio occurrence. The AI may provide buy or sell recommendations for the user's tradeable assets based on the user's historical actions with the same asset or similar assets. Additionally, the AI may ask the user questions about the portfolio to optimize the holdings. For example, the AI may learn that the user has a preference for assets within a certain class or sector (e.g., energy, finance, healthcare, telecommunications, etc.) and provides recommendations for assets within that class or sector. Further, the AI may learn that the user has a preference for characteristics (e.g., pays dividends, short selling, etc.) of these assets and provides recommendations for assets within that class or sector that match the user's preferred characteristics.

According to some embodiments, the recommendation for the tradeable assets can be to purchase a quantity of the tradeable asset, to sell a quantity of the tradeable asset, or to hold the tradeable asset. A recommendation symbol such as a unique typeface for the ticker symbols 504, or other distinguishing feature or icon for the ticker symbols 504 to graphically convey the recommendation to the user. By way of example, the display driver module recommends selling the tradeable asset IMPUY by formatting the ticker symbol 504 bold, with strikethrough. As another example, the recommendation determined by the display deriver module is to hold the tradeable asset with ticker symbol PLTR, as indicated by the italicized, underlined text. The remaining tradeable assets have received “buy” recommendations, as indicated by standard block lettering. A “buy” recommendation informs the user that the conditions specified in the configuration package have been satisfied, justifying the purchase of quantities of the corresponding tradable asset. However, any other distinguishing feature such as color, letter case, stylized font, any other symbol, etc. can be used to convey graphically the recommendation to the user. The interface 500 may further be configured to incorporate alerts and/or sounds to notify a user of a trade recommendation. The user may receive a blinking or static red indication to sell a tradeable asset. The user may receive a blinking green indication to buy a tradeable asset. The user may receive a blinking or static red indication to sell a tradeable asset. The user may receive a blinking or static yellow indication to hold a tradeable asset. The color and presentation (e.g., blinking) may vary. Additionally, the user may receive notifications (e.g., email, mobile application, text messaging) concerning trade recommendations.

The interface 500 may further be configured to present top performing portfolios of other traders and/or the portfolio of traders the user is following. In at least one embodiment, the interface 500 may be configured to display the common holdings of every portfolio the user is following. A common holding may be any predetermined number (e.g., 1 or more) set by the user. For example, by setting the common holding threshold at 2, the interface 500 would present every tradeable asset that at least two other traders are currently holding. An advantage of this presentation is that the user is able to determine common assets that are held by other traders and assess the assets on a single screen, thereby increasing the efficiency of the decision-making process.

Additionally, the user may have access to the portfolios of other users, observing which assets they are holding and the volume. The interface 500 may further be configured to enable the user to select an adjustment feature to mimic a top performing portfolio. For example, if the user selects the adjustment feature, the user will trade into the same positions as the other portfolio, based on (for example) proportionality of available assets.

With reference to FIG. 6, a flow diagram of a process 600 for generating a dynamic interface with a computing system to display real-time information about a plurality of tradeable assets within a portfolio is illustrated. The process 600 includes receiving 610 data for each of the plurality of tradeable assets. The data may be received from multiple databases and aggregated. A node is generated 612 for each tradeable asset based on the data. A determination 614, 616, 618, 620 of a volume, price change, recommendation action, and trading momentum is made for each tradeable asset. The dynamic interface is generated 622 to display the real-time information about the plurality of tradeable assets.

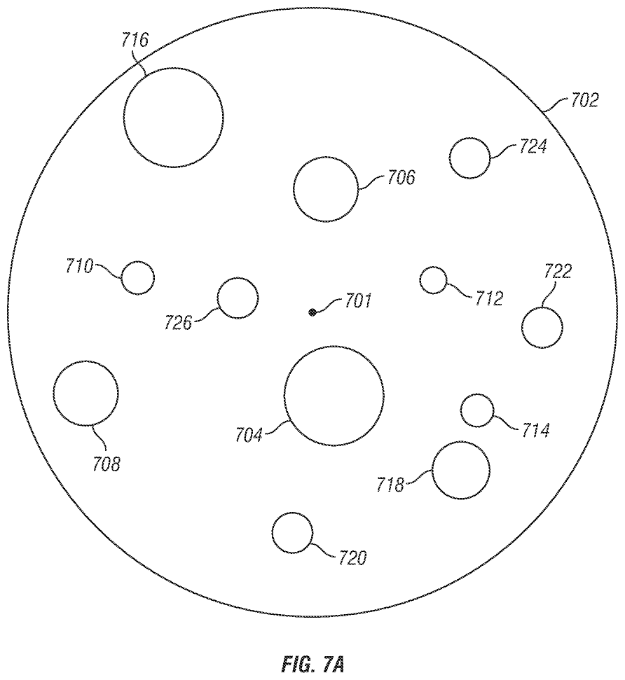

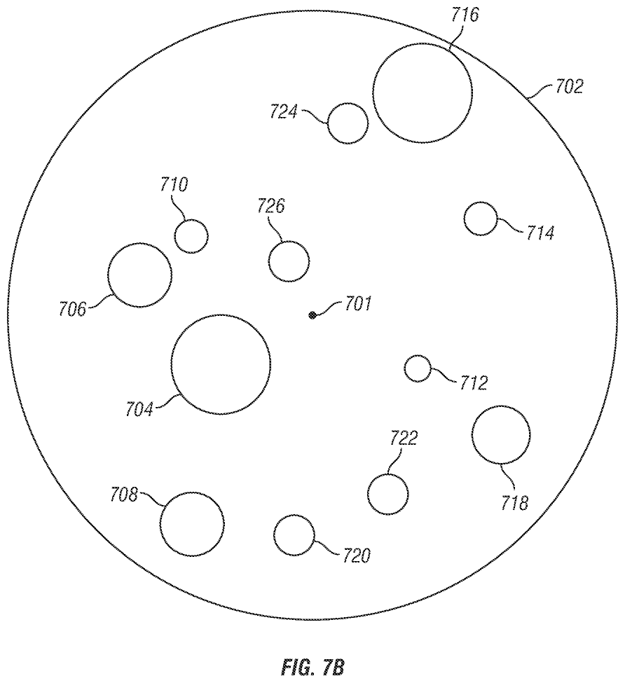

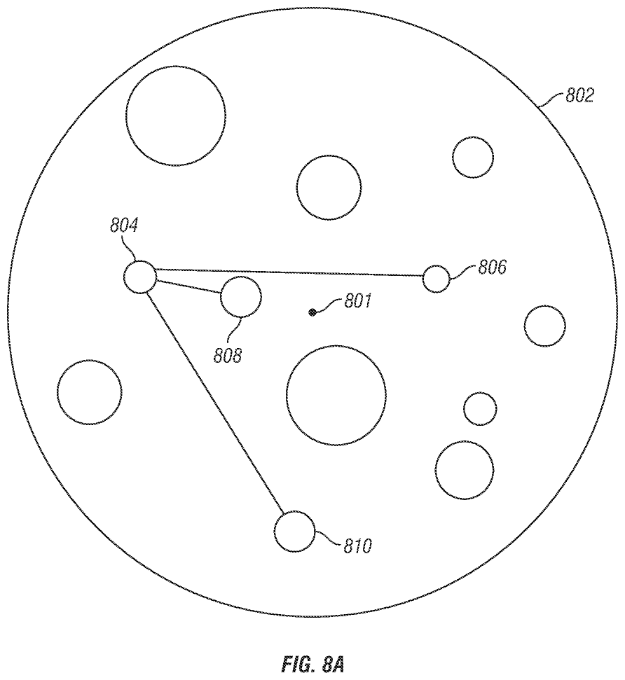

Referring to FIGS. 7A and 7B, dynamic interfaces of a plurality of nodes representing tradeable assets are illustrated at two different time period. The dynamic interface includes a circular common area 702 where the plurality of nodes are positioned. As described herein, the plurality of nodes include characteristics based on the data of the tradeable assets.

A first characteristic may be indicative of a volume owned by the user relative to the plurality of tradeable assets within the portfolio. The tradeable assets are positioned between a center 701 of the circular common area and an outer edge of the circular common area, with the position based on the first characteristic. In one embodiment, tradeable assets having a larger volume may be positioned towards the center 701 and tradeable assets having a smaller volume may be positioned towards the outer edge. Additionally, the circular common area 702 may be segmented into bands corresponding to various ranges of volume. For example, node 704 would have a larger volume relative to the portfolio because it is positioned towards the center 701. In contrast, node 722 would have a smaller volume relative to the portfolio because it is positioned towards the outer edge of the circular common area. In another embodiment, tradeable assets having a larger volume may be positioned towards the outer edge and tradeable assets having a smaller volume may be positioned towards center 701 of the circular common area. For example, node 716 would have a larger volume relative to the portfolio because it is positioned towards the outer edge. In contrast, node 722 would have a smaller volume relative to the portfolio because it is positioned towards the center 701 of the circular common area.

A second characteristic may be indicative of a trading momentum of a tradeable asset. The nodes of the tradeable asset have an angular movement based within the circular common area, with the direction indicating how the asset is trading (e.g., asset is increasing or decreasing in value). Tradeable assets having a positive trading momentum have a clockwise angular movement, with the speed of the angular movement increasing with a larger positive trading momentum value. Tradeable assets having a negative trading momentum have a counterclockwise angular movement, with the speed of the angular movement increasing with a larger negative trading momentum value. The speed of the trading momentum can be based on a 10-day trend. The 10-day trend may be defined as the change (if any) between the previous closing session price and the closing price 10 days prior. Alternatively, the trend may be based on a different number of days. The speed of the trading momentum can be segmented into groups (e.g., quartiles) corresponding to the degree of change in the trend. For example, a trading momentum in the first quartile may correspond to a change between (±) 0%-2% and correlates to the node having a first rotation speed (e.g., very slow rotation). A trading momentum in the second quartile may correspond to a change between (±) 3%-6% and correlates to the node having a second rotation speed (e.g., slow rotation). A trading momentum in the third quartile may correspond to a change between (±) 7%-10% and correlates to the node having a third rotation speed (e.g., medium rotation). A trading momentum in the fourth quartile may correspond to a change between (±) 10% and correlates to the node having a fourth rotation speed (e.g., fast rotation).

For example, nodes 704, 710, 712, 716, 726, and 722 have a positive trading momentum with a clockwise angular movement, indicating that the value of the asset is increasing. Further, node 722 has a large positive trading momentum because its position has drastically changed during the time period, indicating that the value of the asset is rapidly increasing. In contrast, node 710 has a small positive trading momentum because its position has minimally changed during the time period, indicating that the value of the asset is slowly increasing. The trading momentum may be based on percentage of new buyers/sellers of the tradeable assets and/or the volume of the tradeable asset that is being purchased or sold. The trading momentum may additionally or alternatively be based on the rate of change in the market price of the tradeable asset.

Nodes 706, 708, 714, 718, and 724 have a negative trading momentum with a counterclockwise angular movement, indicating that the value of the asset is decreasing. Node 714 has large negative trading momentum because its position has drastically changed during the time period, indicating that the value of the asset is rapidly decreasing. In contrast, node 718 has a small negative trading momentum because its position has minimally changed during the time period, indicating that the value of the asset is slowly decreasing. Node 720 does not have a trading momentum because it is in the same position, indicating that the value of the asset has not changed. It is advantageous to provide a user with the above information in this manner because the user can assess their entire portfolio in a single window. For example, the user can assess whether a heavily held asset is rapidly losing value that they should decrease their position. Alternatively, the user can assess whether a nominally held asset is rapidly gaining value that they should increase their position.

With continued reference to FIGS. 7A and 7B, a third characteristic is indicative of a price change is the size of the node, with increasing size correlated to increasing value and decreasing size correlated to decreasing value. The third characteristic may be based on the market open price of the tradeable asset. For example, node 716 has a large node size, indicating that the value of the asset has significantly increased since the market open price of the asset. In contrast, node 714 has a small node size, indicating the value of the asset has marginally decreased since the market open price of the asset. Further, the size of the nodes may be segmented into a plurality of sizes. For example, the nodes may be segmented into a small size correlating to a change between a change between (±) 0%-0.5%, a medium size correlating to a change between a change between (±) 0.5%-1%, a large size correlating to a change between a change between (±) 1%-4%, and an extra-large size correlating to a change between a change between (±) 4%.

Additionally, the tradeable assets may have a fourth characteristic indicative of a recommended trading action. Similar to the recommendation described in FIG. 5, the recommended trading action may correlate to a buy recommendation, a sell recommendation, or a hold recommendation. For example, the asset corresponding to of node 722 may have a buy recommendation because of the large positive trading momentum and large volume.

Additionally, the asset corresponding to node 714 may have a sell recommendation because the asset is rapidly losing value and has a large volume. Additionally, the asset corresponding to node 718 may have a hold recommendation the asset is not rapidly losing value. In some examples, the buy recommendation may be a green node, the sell recommendation may be a red node, and the hold recommendation may be a yellow node.

A fifth characteristic may also be indicative of the daily price change of the tradeable asset, with nodes exhibiting a visual indicator. For example, the visual indicator of the nodes may be a color, with yellow correlating to a ±0.5% change, green correlating to a change above 0.5%, and red correlating to a change below −0.5%. Further, the intensity (or darkness) of the node may indicate a greater percentage change. For example, a dark green node would correlate to a change significantly greater than 0.5%, and a light (or faint) red node would correlate to a change at (or slightly above) −0.5%.

A sixth characteristic may also be indicative of the daily price change of the tradeable asset, with nodes exhibiting an audio indicator. For example, the audio indicator of the nodes may be a sound, with a bird (or chirping) sound correlating to a positive change, a beeping sound correlating to a negative change, and no sound correlating to no (or an insignificant) change. Further, the intensity (or darkness) of the sound may indicate a greater percentage change. For example, a rapidly chirping sound would correlate to significant positive change (e.g., greater than 5%), and a slow (or intermittent) beeping sound would correlate to a slight negative change (e.g., less than 0.5%).

A seventh characteristic may be indicative of one or more performance indicators of the tradeable asset. While the tradeable assets are generally presented as nodes, the tradeable assets may be presented in other shapes corresponding to a performance indicator. Additionally, the shapes of the performance indicators may also include visual indicators, as described above. The performance indicators may include a Bollinger Band, V-Weighted Average Price (VWAP), Relative Strength Index (RSI), and Intraday Momentum Index (IMI). In one embodiment, the Bollinger Band indicator is represented by a triangle shape, the VWAP is represented by a square shape, the RSI is represented by a hexagonal shape, and the IMI is represented by a diamond shape. For example, when the upper and lower Bollinger Bands are close together (e.g., bandwidth), the visual indicator of the triangle will appear green, indicating low volatility. On the other hand, when the upper and lower Bollinger Bands are far apart (e.g., bandwidth), the visual indicator of the triangle will appear red, indicating high volatility. When the VWAP is above the current trading price of the tradeable asset (i.e., undervalued), the visual indicator of the square will appear green. Alternatively, when the VWAP is above the current trading price of the tradeable asset (i.e., overvalued), the visual indicator of the square will appear red. When the RSI of the tradeable is below a first threshold value (e.g., 30), the visual indicator of the hexagon will appear green. Alternatively, when the RSI of the tradeable is above a second threshold value (e.g., 70), the visual indicator of the hexagon will appear red. Similarly, when the IMI of the tradeable is below a first threshold value (e.g., 30), the visual indicator of the hexagon will appear green. Alternatively, when the IMI of the tradeable is above a second threshold value (e.g., 70), the visual indicator of the hexagon will appear red. It is understood that the user may be able to set the threshold values for the performance indicators. In another embodiment, the visual indicator may be a star-shape when multiple performance indicators are triggered.

In each of the above-described characteristics for the tradeable assets/nodes, artificial intelligence (AI) may be employed to manage the user's investments based performance. The AI may suggest trading recommendations based on, for example, the user's trading tendencies. For example, the AI may provide buy or sell recommendations for the user's tradeable assets based on the user's historical threshold values of performance indicators. Additionally, the AI may provide buy or sell recommendations for the user's tradeable assets based on the user's historical actions with the same asset or similar assets. For example, the AI will understand when the user prefers to buy or sell at certain trading momentum speed, momentum direction, percent change in price, etc.

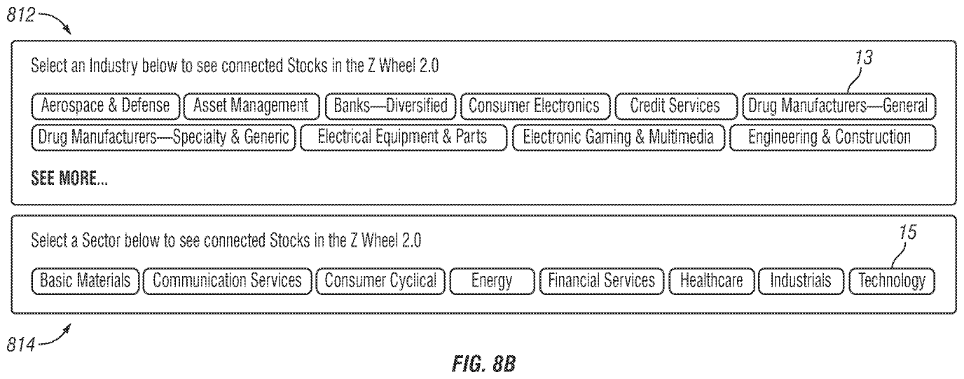

Referring to FIGS. 8A and 8B, illustrations of a connection indicator between tradeable assets corresponding to industries and sectors are illustrated. The user may select a node within the circular common area 802 to identify assets that are part of the same industry 812 and/or sector 814. For example, if the user selects node 804 and the drug manufacturing industry 813 or technology sector 815, the dynamic interface displays the connection indicator between node 804 and nodes 806, 808, and 810. The connection indicator provides the user with a quick assessment of which of their assets are in their portfolio, how those assets are trading, and the size of their position in the industry or sector relative to the portfolio. The industry may be, for example, aerospace, asset management, banking, consumer electronics, credit services, drug manufacturing, electrical equipment, multimedia, engineering, and construction. The industry may be, for example, basic materials, communication services, consumer cyclical, energy, financial services, healthcare, industrials, and technology.

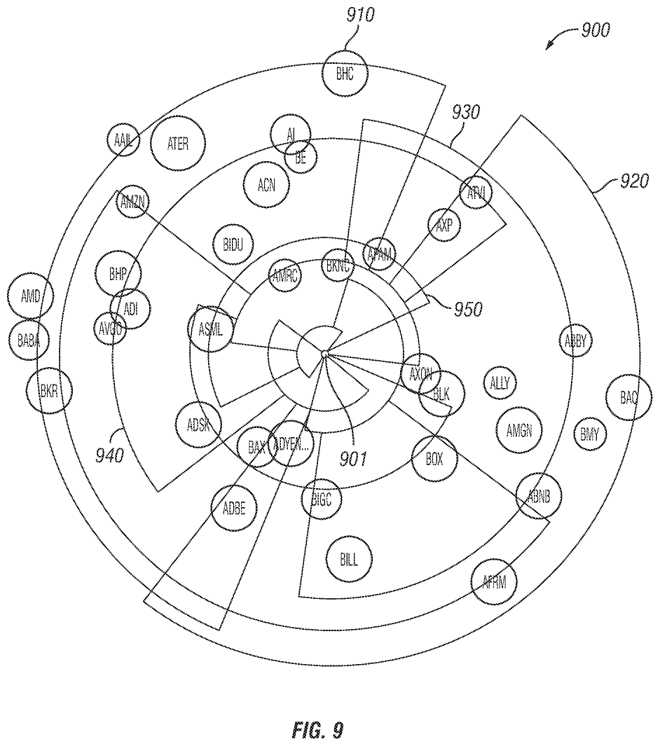

FIG. 9 is an illustration of a dynamic interface 900 of a plurality of wedges representing tradeable asset classes. The dynamic interface 900 comprises a plurality of nodes 910 disposed within a common area. The dynamic interface 900 further comprises a plurality of wedges 920, 930, 940, and 950 arranged within the common area. The plurality of wedges 920, 930, 940, and 950 correspond to various asset classes. The plurality of wedges 920, 930, 940, and 950 revolve around a center point 901 of the common area. The plurality of wedges 920, 930, 940, and 950 comprise characteristics based on the data of the asset classes. A first characteristic may be indicative of a volume of the tradeable assets within the asset class relative to the portfolio is the size of the wedge. Wedges with larger sizes correspond to the user holding a large amount of tradeable assets within the class relative to the portfolio. In contrast, wedges with smaller sizes correspond to the user holding a small amount of tradeable assets within the class relative to the portfolio. For example, wedge 920 is larger than wedge 950, indicating that the user holds significantly more assets corresponding to the class in wedge 920 than those in wedge 950.

A second characteristic may be indicative of a trading momentum of an asset class. Similar to nodes described in FIGS. 7A and 7B, the wedges of the asset class have an angular movement based within the common area, with the direction indicating how the class is trading (e.g., asset class is increasing or decreasing in value). Asset classes having a positive trading momentum have a clockwise angular movement, with the speed of the angular movement increasing with a larger positive trading momentum value. Asset classes having a negative trading momentum have a counterclockwise angular movement, with the speed of the angular movement increasing with a larger negative trading momentum value.

A third characteristic may be indicative of a recommended trading action. Similar to the recommendation described in FIGS. 7A and 7B, the recommended trading action may correlate to a buy recommendation, a sell recommendation, or a hold recommendation. In this example, a buy recommendation for a particular asset class corresponds to recommending that the user increase their position in the assets already in their portfolio. Alternatively, a buy recommendation for a particular asset class corresponds to recommending that the user purchase additional assets within the class that are not already held in their portfolio. Similarly, a sell recommendation for a particular asset class corresponds to recommending that the user decrease their position in the assets already in their portfolio. In some examples, the buy recommendation may be a green wedge, the sell recommendation may be a red wedge, and the hold recommendation may be a yellow wedge. The asset class may be pharmaceutical, social media, electric vehicles, and energy.

The dynamic interface 900 may further be configured to present top performing portfolios of other traders and/or the portfolio of traders the user is following. In at least one embodiment, the dynamic interface 900 may be configured to display the common holdings of every portfolio the user is following. A common holding may be any predetermined number (e.g., 1 or more) set by the user. For example, by setting the common holding threshold at 2, the dynamic interface 900 would present every tradeable asset that at least two other traders are currently holding. An advantage of this presentation is that the user is able to determine common assets that are held by other traders and assess the assets on a single screen, thereby increasing the efficiency of the decision-making process.

In another embodiment, the dynamic interface 900 may further be configured to present additional information of a tradeable asset and/or tradeable asset class. For example, by hovering over a node or wedge in the dynamic interface 900, a user will be able to view detailed information about the asset, which is advantageous because a user can further investigate an asset after identifying on the dynamic interface 900 because of its characteristics. Detailed information may include Bollinger Band values, VWAP, RSI, IMI, share price, share price change, and percent change in share price.

In each of the above-described characteristics for the tradeable assets/wedges, artificial intelligence (AI) may be employed to manage the user's investments based on performance. The AI may suggest trading recommendations based on, for example, the user's trading tendencies. For example, the AI may provide buy or sell recommendations for the user's tradeable assets based on the user's historical threshold values of performance indicators. Additionally, the AI may provide buy or sell recommendations for the user's tradeable assets based on the user's historical actions with the same asset or similar assets. For example, the AI will understand when the user prefers to buy or sell at certain trading momentum speed, momentum direction, percent change in price, etc.

The embodiments of the above-described interface 500 and dynamic interface 900 may be combined with “gamification” features. Any of a variety of ways to “gamify” these embodiments can be used, for example, to encourage feedback, to reward users for attaining a status level (e.g., labeled as a top or successful trader), to simply encourage more use of the platform or service in general, to encourage collaboration between users, and/or enable users to monetize their trading skills. In one embodiment, users can charge others to access their portfolio (e.g., view their interface 500 and/or dynamic interface 900). This is advantageous when a user has developed a reputation as a successful trader and gained attention (or followers), thereby increasing the amount of money a user can make for allowing access to their portfolio. Additionally, in some embodiments, users may be encouraged/rewarded for posting their portfolios, for example, to see if other users are interested in their investments.

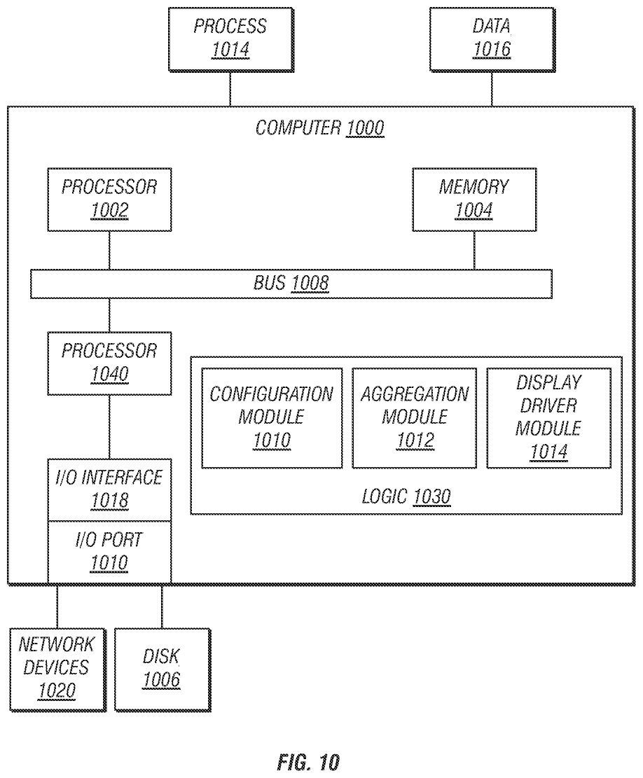

FIG. 10 illustrates an example of a computing device that is configured and/or programmed with one or more of the example systems and methods described herein, and/or equivalents. The exemplary computing device may be a computer 600 that includes a processor 1002, a memory 1004, and input/output ports 1010 operably connected by a bus 1008. In one example, the computer 1000 may include logic 1030 configured to control operation of a display 102 with respect to the system 100 shown in FIG. 1. In different examples, the logic 1030 may be implemented in hardware, a non-transitory computer-readable medium with stored instructions, firmware, and/or combinations thereof. While the logic 1030 is illustrated as a hardware component attached to the bus 1008, it is to be appreciated that in other embodiments, the logic 1030 could be implemented in the processor 1002, stored in memory 1004, or stored in disk 1006.

In one embodiment, logic 1030 or the computer 1000 is a means (e.g., structure: hardware, non-transitory computer-readable medium, firmware) for performing the actions described. In some embodiments, the computer 1000 may be a server operating in a cloud computing system, a server configured in a Software as a Service (SaaS) architecture, a smartphone, laptop, tablet computing device, and so on.

The means may be implemented, for example, as an ASIC programmed to authorize communications between members, and limit communications to authorized members. The means may also be implemented as stored computer executable instructions that are presented to computer 1000 as data 1016 that are temporarily stored in memory 1004 and then executed by processor 1002.

Logic 1030 may also provide means (e.g., hardware, non-transitory computer-readable medium that stores executable instructions, firmware) for performing the operations regarding controlling the display 102 as described herein.

Generally describing an illustrative configuration of the computer 1000, the processor 1002 may be a variety of various processors including dual microprocessor and other multi-processor architectures. A memory 1004 may include volatile memory and/or non-volatile memory. Non-volatile memory may include, for example, ROM, PROM, and so on. Volatile memory may include, for example, RAM, SRAM, DRAM, and so on.

A storage disk 1006 may be operably connected to the computer 1000 via, for example, an input/output (I/O) interface (e.g., card, device) 1018 and an input/output port 1010. The disk 1006 may be, for example, a magnetic disk drive, a solid-state disk drive, a floppy disk drive, a tape drive, a Zip drive, a flash memory card, a memory stick, and so on. Furthermore, the disk 1006 may be a CD-ROM drive, a CD-R drive, a CD-RW drive, a DVD-ROM, and so on. The memory 1004 can store a process 1014 and/or a data 1016, for example. The disk 1006 and/or the memory 1004 can store an operating system that controls and allocates resources of the computer 1000.

The computer 1000 may interact with input/output (I/O) devices via the I/O interfaces 1018 and the input/output ports 1010. Input/output devices may be, for example, a keyboard, a microphone, a pointing and selection device, cameras, video cards, displays, the disk 1006, the network devices 1020, and so on. The input/output ports 1010 may include, for example, serial ports, parallel ports, and USB ports.

The computer 1000 can operate in a network environment and thus may be connected to the network devices 1020 via the I/O interfaces 1018, and/or the I/O ports 1010. Through the network devices 1020, the computer 1000 may interact with a network. Through the network, the computer 1000 may be logically connected to remote computers. Networks with which the computer 1000 may interact include, but are not limited to, a LAN, a WAN, and other networks.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

### Exemplary Artificial Intelligence Implementations

Advantageously, most or all of the functionality of systems, methods, and platforms described discussed above may be implemented or assisted by the use of artificial intelligence (AI). Those skilled in the pertinent fields of art are knowledgeable about the development and use of artificial intelligence, and thus a detailed discussion of these will not be included here. However, the AI principles for providing suggestions to manage a portfolio disclosed in U.S. Pat. No. 11,443,380 may be utilized and is incorporated by reference. Additionally, the implementation of AI into some or all of the unique functionality of systems, methods, and platforms designed or constructed in accordance with the disclosed principles results in novel applications and results. AI may not only do a better job of including all relevant information about the user's trading preferences that the user may forget to employ in the portfolio but may also better present that information. Such better presentation may also be tailored to the user's purpose for using the systems, methods, and platforms, such as tailoring the portfolio for the best presentation to trade assets.

For example, as mentioned above, the AI may suggest trading recommendations based on, for example, the user's trading tendencies. For example, the AI may provide buy or sell recommendations for the user's tradeable assets based on the user's historical actions for candlestick events, insider trading events, upcoming dividends (or no dividends), at the money, and/or natural ratio occurrence. The AI may provide buy or sell recommendations for the user's tradeable assets based on the user's historical actions with the same asset or similar assets. Additionally, the AI may ask the user questions about the portfolio to optimize the holdings. For example, the AI may learn that the user has a preference for assets within a certain class or sector (e.g., energy, finance, healthcare, telecommunications, etc.) and provides recommendations for assets within that class or sector. Further, the AI may learn that the user has a preference for characteristics (e.g., pays dividends, short selling, etc.) of these assets and provides recommendations for assets within that class or sector that match the user's preferred characteristics.

Additionally, the AI may suggest trading recommendations based on, for example, the user's trading tendencies. For example, the AI may provide buy or sell recommendations for the user's tradeable assets based on the user's historical threshold values of performance indicators. Additionally, the AI may provide buy or sell recommendations for the user's tradeable assets based on the user's historical actions with the same asset or similar assets. For example, the AI will understand when the user prefers to buy or sell at certain trading momentum speed, momentum direction, percent change in price, etc. Additionally, the AI may ask the user questions about the portfolio to optimize the holdings. For example, the AI may learn that the user has a preference for assets within a certain class or sector (e.g., energy, finance, healthcare, telecommunications, etc.) and provides recommendations for assets within that class or sector. Further, the AI may learn that the user has a preference for characteristics (e.g., pays dividends, short selling, momentum tendencies, etc.) of these assets and provides recommendations for assets within that class or sector that match the user's preferred characteristics. Additionally, in any and all of the described situations, a user may ask the AI questions about their portfolio to obtain information or recommendations. For example, the user may ask the AI for suggestions on investment strategy, how to manage the portfolio, buy/sell actions, or portfolios of other users that have better returns.

In yet another aspect, the AI may suggest portfolios of other users for the user to follow, based on the user's holdings and trading tendencies. For example, the AI may identify portfolios of other users with similar volume but higher returns. Additionally, the AI may identify portfolios of other users with similar trading tendencies but higher returns. The AI may suggest that the user follow these portfolios to help improve the user's returns. The AI may also suggest investment actions for the user to take based on the suggested portfolios. For example, the AI may suggest that the user trade out of a certain asset and buy a similar that is held a followed user and producing better returns.

Other potential implementations of AI for users are the use of AI to help customize the interface 500 and/or the dynamic interface 900. For example, the user may interact with the AI to answer questions concerning preference about information presented in the interface 500 and/or the dynamic interface 900. The user may learn how the interface 500 and/or the dynamic interface 900 operate and why they should have certain information presented. Based on the user's answers, the AI will provide suggestions on which information should be presented in the interface 500 and/or the dynamic interface 900, and the AI may generally provide the user with educational information on finance as well as how the educational information may be visualized on the interface 500 and/or the dynamic interface 900. Additionally, the AI may periodically follow-up with the user about the information preferences, as the preferences may change over time and based on the user's trading tendencies evolving.

The following sections' content includes definitions of selected terms employed herein. These definitions include various examples and/or forms of components that fall within the scope of a term and that may be used for implementation. These examples are not intended to be limiting. Both singular and plural forms of terms may be included within these definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure,” as used herein, is an organization of data in a computing system that is stored in a memory medium, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium,” as used herein, refers to a non-transitory medium that stores instructions and/or data configured to perform one or more of the disclosed functions when executed by at least a single processor. Data may function as instructions in some embodiments. A computer-readable medium may take forms, including, but not limited to, non-volatile media or volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read-only memory (ROM), a memory chip or card, a memory stick, solid-state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic,” as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a goal, then hardware would be selected to implement functions. If a lower cost is desired, then stored instructions/executable application would be selected to implement the functions.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

To the extent that the term “includes” or “including” is employed in the detailed description or the claims, it is intended to be inclusive in a manner similar to the term “comprising” as that term is interpreted when employed as a transitional word in a claim.

What is claimed is:

1. A method for generating a dynamic interface with a computing system to display real-time information about a plurality of tradeable assets within a portfolio, the method comprising:
receiving data for each of the plurality of tradeable assets, wherein the data is received in real-time;
generating a node for each tradeable asset of the plurality of tradeable assets based on the data of each tradeable asset, wherein each node includes:
a first characteristic indicative of a volume relative to the plurality of tradeable assets within the portfolio, and
a second characteristic indicative of a trading momentum; and
generating the dynamic interface to display the real-time information about the plurality of tradeable assets, wherein:
the dynamic interface includes the node for each tradeable asset located within a circular common area of the dynamic interface,
each node has a position between a center of the circular common area and an outer edge of the circular common area, the position based on the first characteristic of each node,
one or more nodes has an angular movement based on the second characteristic, and
the dynamic interface updates with real-time changes in the data of any of the plurality of tradeable assets.

2. The method of claim 1, wherein:
each node further includes a third characteristic indicative of a price change, and a fourth characteristic indicative of a recommended trading action; and
generating the dynamic interface, each node has a size based on the third characteristic, and each node has a color based on the fourth characteristic.

3. The method of claim 1, further comprising generating a connection indicator between a node of a user-selected tradeable asset and nodes of one or more related tradeable assets, wherein the connection indicator is displayed on the dynamic interface.

4. The method of claim 3, wherein the connection indicator is based on the user-selected tradeable asset and the one or more related tradeable assets being within an industry.

5. The method of claim 4, wherein the industry comprises at least one of: aerospace, asset management, banking, consumer electronics, credit services, drug manufacturing, electrical equipment, multimedia, engineering, and construction.

6. The method of claim 5, wherein the connection indicator is based on the user-selected tradeable asset and the one or more related tradeable assets being within the same sector.

7. The method of claim 6, wherein the sector comprises at least one of: basic materials, communication services, consumer cyclical, energy, financial services, healthcare, industrials, and technology.

8. The method of claim 2, wherein the third characteristic is based on a market open price of the tradeable asset, further wherein the size increases with a positive price change and decreases with a negative price change, and further wherein the color of the node relates to a buy recommendation, a sell recommendation, or a hold recommendation.

9. The method of claim 1, wherein the angular movement of a node is clockwise when trading momentum is positive, and wherein a speed of the angular movement increases with a larger positive trading momentum value.

10. The method of claim 1, wherein the angular movement of a node is counterclockwise when trading momentum is negative, and wherein a speed of the angular movement increases with a larger negative trading momentum value.

11. The method of claim 1, further comprising:
receiving data for each of a plurality of asset classes, wherein the data is received in real-time; and
generating a wedge for each asset of the plurality of asset classes based on the data of each of the plurality of asset classes, wherein each wedge includes:
a third characteristic indicative of a volume relative to the plurality of tradeable assets within the portfolio,
a fourth characteristic indicative of a recommended trading action, and
a fifth characteristic indicative of trading momentum of assets within the asset class.
wherein the dynamic interface includes:
the plurality of concentric wedges arranged within the circular common area, and
one or more concentric wedges has an angular movement based on the fifth characteristic of each wedge,
each wedge has a color based on the fourth characteristic,
each wedge has a size based on the third characteristic; and
the asset class is selected from the group consisting of pharmaceutical, social media, electric vehicles, and energy.

12. The method of claim 11, wherein the angular movement of each wedge is clockwise when trading momentum of the asset class is positive, and wherein a speed of the angular movement increases with a larger positive trading momentum value.

13. The method of claim 11, wherein the angular movement of each wedge is counterclockwise when trading momentum is negative, and wherein a speed of the angular movement increases with a larger negative trading momentum value.

14. A non-transitory computer readable medium for storing instructions that when executed by one or more processors cause the one or more processors to:
receive data for each of a plurality of tradeable assets, wherein the data is received in real-time;
generate a node for each tradeable asset of the plurality of tradeable assets based on the data of each tradeable asset, wherein each node includes:
a first characteristic indicative of a volume relative to the plurality of tradeable assets within the portfolio, and
a second characteristic indicative of a trading momentum;
generate a dynamic interface to display the real-time information about the plurality of tradeable assets, wherein:
the dynamic interface includes the node for each tradeable asset located within a circular common area of the dynamic interface,
each node has a position between a center of the circular common area and an outer edge of the circular common area, the position based on the first characteristic of each node,
one or more nodes has an angular movement within the circular common area, the angular movement based on the second characteristic, and
the dynamic interface updates with real-time changes in the data of any of the plurality of tradeable assets.

15. The non-transitory computer readable medium of claim 14, wherein:
each node further includes a third characteristic indicative of a price change, and a fourth characteristic indicative of a recommended trading action; and
the computer readable medium stores additional instructions that, when executed by the one or more processors, causes the one or more processors to generate the dynamic interface such that each node has a size based on the third characteristic, and each node has a color based on the fourth characteristic.

16. The non-transitory computer readable medium of claim 14, wherein the computer readable medium stores additional instructions that, when executed by the one or more processors, causes the one or more processors to generate a connection indicator between a node of a user-selected tradeable asset and nodes of one or more related tradeable assets, wherein the connection indicator is displayed on the dynamic interface.

17. The non-transitory computer readable medium of claim 16, wherein the connection indicator is based on the user-selected tradeable asset and the one or more related tradeable assets being within an industry, and wherein the industry comprises at least one of: aerospace, asset management, banking, consumer electronics, credit services, drug manufacturing, electrical equipment, multimedia, engineering, and construction.

18. The non-transitory computer readable medium of claim 16, wherein the connection indicator is based on the user-selected tradeable asset and the one or more related tradeable assets being within the same sector, and wherein the sector comprises at least one of: basic materials, communication services, consumer cyclical, energy, financial services, healthcare, industrials, and technology.

19. The non-transitory computer readable medium of claim 15, wherein the third characteristic is based on a market open price of the tradeable asset, further wherein the size increases with a positive price change and decreases with a negative price change, and further wherein the color of the node relates to a buy recommendation, a sell recommendation, or a hold recommendation.

20. The non-transitory computer readable medium of claim 14, wherein:
the angular movement of a node is clockwise when trading momentum is positive, and the angular movement of a node is counterclockwise when trading momentum is negative; and
a speed of the angular movement increases with a larger positive trading momentum value, and the speed of the angular movement increases with a larger negative trading momentum value.
